(19) United States
(12) Patent Application Publication
(10) Pub. No.: US 2010/0283350 A1
(43) Pub. Date: Nov. 11, 2010

(54) FLYWHEEL GENERATOR SYSTEM HAVING OPEN SHAPED LOOP COILS

(76) Inventor: Eduard G. Surodin, Brooklyn, NY (US)

Correspondence Address: DONALD W. MEEKER, 924 EAST OCEAN FRONT, # E, NEWPORT BEACH, CA, 92661, US

(21) Appl. No.: 12/437,540

(22) Filed: May 7, 2009

(51) Int. Cl. H02K 3/04; H02K 53/00

(52) U.S. Cl. 310/208; 415/916

(57) ABSTRACT

A series of elongated oval wire windings bent into open C-shaped or other loop shape coils are positioned around a flywheel. Magnets, mating the loop opening shape, extend from the outer edge of the flywheel on a thin disc to pass through the coils to generate electricity with the spin of the flywheel. With no magnetic material is the coils there is no magnetic resistance created thereby providing more efficient electricity generation.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates generally to power generation devices, and in particular to a flywheel generator system and method of generating electricity which conserves electric energy by the use of a series of C-shaped or other shape looped coils positioned around a flywheel with magnets extending from the outer edge of the flywheel passing through the coils to generate electricity and with no magnetic material is the coils there is no resistance created thereby providing more efficient electricity generation.

2. Description of Related Art including information disclosed under 37 CFR 1.97 and 1.98

As is known in the prior art, electric generator methods of energy production are based on the principal of electromagnetic induction. The stator of the generator has magnetic material inside of the coil, and when the rotor moves the magnets close to the coil and the magnets are attracted by metal inside of the coil, the metal becomes a magnet itself by magnetic induction, and the impulse of the magnetic field produces electric current in the coil.

The problem with prior art electric generators is that a rotor with permanent or electric magnets is attracted by magnetic material inside of the coils of the stator to make the rotor spin inside the stator with high magnetic resistance. The more load to the generator the higher the resistance, and more mechanical power must be applied to the rotor of the generator in the order to produce electric energy.

U.S. Pat. No. 5,341,060, issued Aug. 23, 1994 to Kawamura, claims an engine having a flywheel which has a high peripheral speed even when the engine rotates at a low speed. The flywheel has a plurality of permanent magnets mounted on an outer circumference thereof and having alternately different magnetic poles. A stator is disposed in confronting relation to radially outer ends of the permanent magnets. Electric energy induced by the stator upon rotation of the flywheel is supplied to a rotary electric machine combined with a turbocharger to assist the turbocharger in supplying air under pressure to the engine when the engine rotates at low speed.

U.S. Pat. No. 3,629,632, issued Dec. 21, 1971 to Loupe, describes a generator for use with a small rotary engine incorporating permanent magnets in its flywheel, the generator being mounted exteriorly of the flywheel and within the flywheel housing, if any is used. The magnets move relative to a stator having a “double-E” configuration with two poles, each of which carry a pair of windings. The windings on each pole are connected in electrical opposition through diodes to supply the desired electrical current. The stator structure is laminated and has preferred physical dimensions.

U.S. Pat. No. 5,214,333, issued May 25, 1993 to Kawamura, discloses an engine having a flywheel which has a high peripheral speed even when the engine rotates at a low speed. The flywheel has a plurality of permanent magnets mounted on an outer circumference thereof and having alternately different magnetic poles. A stator is disposed in confronting relation to radially outer ends of the permanent magnets. Electric energy induced by the stator upon rotation of the flywheel is supplied to a rotary electric machine combined with a turbocharger to assist the turbocharger in supplying air under pressure to the engine when the engine rotates at low speed.

U.S. Pat. No. 6,791,225, issued Sep. 14, 2004 to Campbell et al, indicates a flywheel magneto generator having a rotor assembly and a stator assembly. The rotor assembly includes a non-ferromagnetic flywheel and a plurality of magnetic poles that are positioned in spaced relationship around the circumference of the flywheel. The stator assembly includes an E-shaped core with a single magnet mounted on the center leg and coils associated with at least the outer legs. The poles and core may be formed of a bonded iron material. The poles may be joined to the flywheel by press fitting or integral molding, among other methods.

U.S. Pat. No. 7,132,775, issued Nov. 7, 2006 to Oohashi et al, is for a dynamoelectric stator and a method for the manufacture thereof enabling electrical insulation properties to be improved by forming slot-housed portions with a racetrack-shaped cross section to suppress damage to an electrically-insulating coating arising during mounting of a stator winding to a stator core. The construction is such that the slot-housed portions of the stator winding are formed with the racetrack-shaped cross section, and are housed inside slots so as to line up in single columns in a radial direction with a longitudinal direction of the cross section of the slot-housed portions aligned in a circumferential direction. Thus, because short sides of the slot-housed portions facing inner circumferential side surfaces of the slots form convex curved surfaces, the occurrence of damage to the electrically-insulating coating resulting from rubbing between the short sides of the slot-housed portions and the inner circumferential side surfaces of the slots during insertion of the slot-housed portions into the slots is suppressed, thereby improving electrical insulation properties.

U.S. Pat. No. 4,460,834, issued Jul. 17, 1984 to Gottfried, provides an uninterruptible power supply to an external load comprising a flywheel generator, a first motor, a standby generator, and a transfer controller. The flywheel generator is adapted to supply energy to the external load. The first motor is drivingly connected to the flywheel generator. The first motor is adapted to be connected to a source of power external to the power system. The standby generator is electrically connected to the first motor. A standby motor is drivingly connected to the standby generator. The transfer controller is adapted to switchably interconnect the first motor to the source of power and to interconnect the standby generator to the first motor. The flywheel generator comprises a flywheel having a vertical axis, a shaft connected to the flywheel, and a synchronous A.C. generator arranged about the shaft. The standby motor is a diesel engine having an electric starter. A voltage regulator is electrically connected about the output of the flywheel generator.

U.S. Pat. No. 7,126,233, issued Oct. 24, 2006 to Thomas et al, shows a method and apparatus for generating power in a rotating environment without access to the axis of rotation. A non-center engagement generator is implemented within the rotating reference frame of a vehicle wheel. Further, a method and apparatus detect a potential rollover state and prevent occurrence of a rollover state or eliminate a rollover state once attained.

U.S. Pat. No. 6,891,295, issued May 10, 2005 to Maritomi et al, puts forth a flywheel magneto generator which comprises a rotor having a magnet attached to an outer circumferential side of a flywheel and a stator constructed by winding a generating coil around a core having a magnetic pole portion opposed to a magnetic pole of the rotor, wherein a through hole is formed in a peripheral wall portion of the flywheel, a yoke plate is provided so as to block one end of the through hole which is opened on an inner circumferential side of a peripheral wall portion of the flywheel, the magnet to which a magnet cover is attached is supported on the yoke plate, and one magnetic pole face of the magnet is opposed to the yoke plate.

What is needed is a more efficient system for generating electricity wherein the coils do not create magnetic resistance.

### BRIEF SUMMARY OF THE INVENTION

An object of the present invention is to provide a flywheel generator system and method of generating electricity which conserves electric energy by the use of a series of C-shaped or other shape looped coils positioned around a flywheel with magnets extending from the outer edge of the flywheel passing through the coils to generate electricity and with no magnetic material is the coils there is no resistance created thereby providing more efficient electricity generation.

In brief, a series of elongated oval wire windings bent into open C-shaped or other loop shape coils are positioned around a flywheel. Magnets, mating the loop opening shape, extend from the outer edge of the flywheel on a thin disc to pass through the coils to generate electricity with the spin of the flywheel. With no magnetic material is the coils there is no resistance created thereby providing more efficient electricity generation.

An advantage of the C-coil (C-shaped coil or semicircular coil) of the present invention is that it doesn't have any magnetic material inside the coil and has a special type of coil winding to allow magnets to pass through the winding of the C-coil itself, and because there is no magnetic material at all, so there is no magnetic resistance at all, so that the magnets to go through the C-coils freely, and electro magnetic induction from the magnets makes the windings of each of the C-coils to produce electric current.

### BRIEF DESCRIPTION OF THE SEVERAL VIEWS OF THE DRAWINGS

These and other details of the present invention will be described in connection with the accompanying drawings, which are furnished only by way of illustration and not in limitation of the invention, and in which drawings:

FIG. 1 is a diagrammatic view of the flywheel electric generator system of the present invention using loop shaped coils of the present invention showing rechargeable batteries powering the electric motor;

FIG. 2 is a diagrammatic side elevational view showing one of the magnets passing through one of the coils of FIG. 1;

FIG. 3 is a diagrammatic front elevational view showing one of the magnets passing through one of the coils of FIG. 1;

FIG. 4 is a diagrammatic top elevational view showing one of the magnets passing through one of the coils of FIG. 1;

FIG. 5 is a diagrammatic back elevational view showing one of the magnets passing through one of the coils of FIG. 1;

FIG. 6 is a diagrammatic view of the flywheel electric generator system of the present invention using loop shaped coils of the present invention showing the flywheel and loop coils housed in a vacuum chamber;

FIG. 7 is a diagrammatic perspective view showing one of the coils of FIG. 1 having a circular loop opening showing the wires wound into the loop;

FIG. 8 is a diagrammatic perspective view showing one of the coils of FIG. 1 having a rectangular loop opening showing the wires wound into the loop.

### DETAILED DESCRIPTION OF THE INVENTION

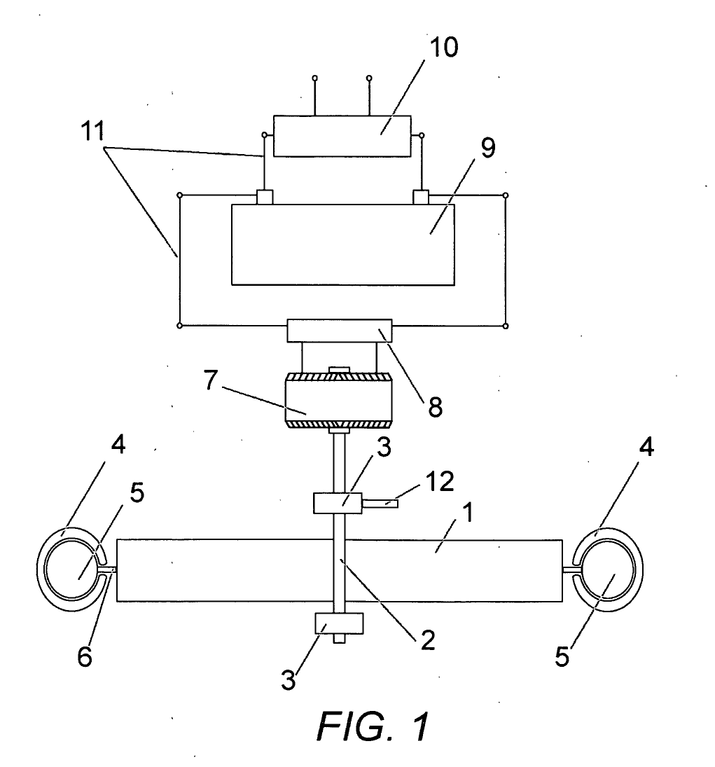

In FIGS. 1-8, a flywheel electric generator system 20 uses loop shaped coils 4 encircling a spinning flywheel 1 so that a series of mating shaped permanent magnets 5 attached to a disc 6 extending from the outer perimeter of the flywheel 1 with the shaped magnets 5 passing through the mating shaped coil openings 17 and 1 7A to generate electricity in the coils.

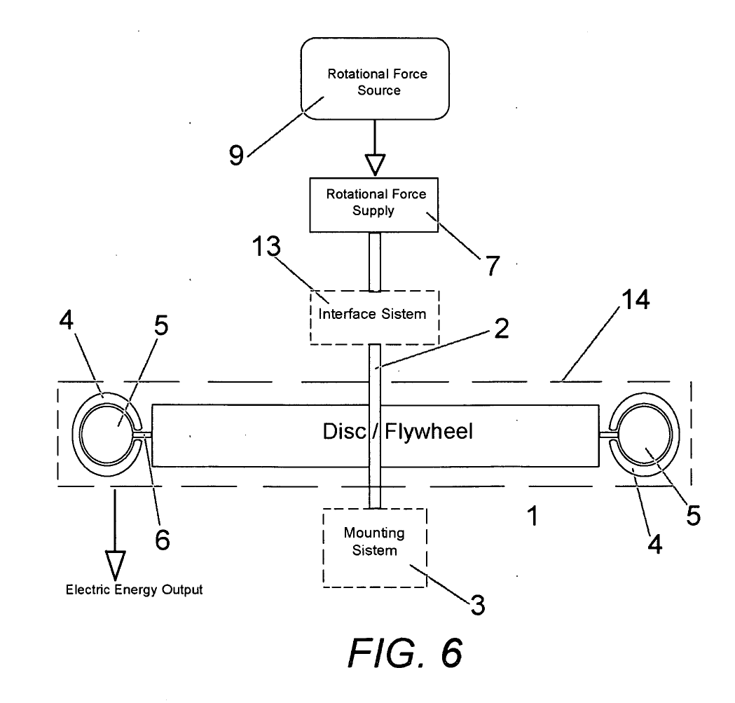

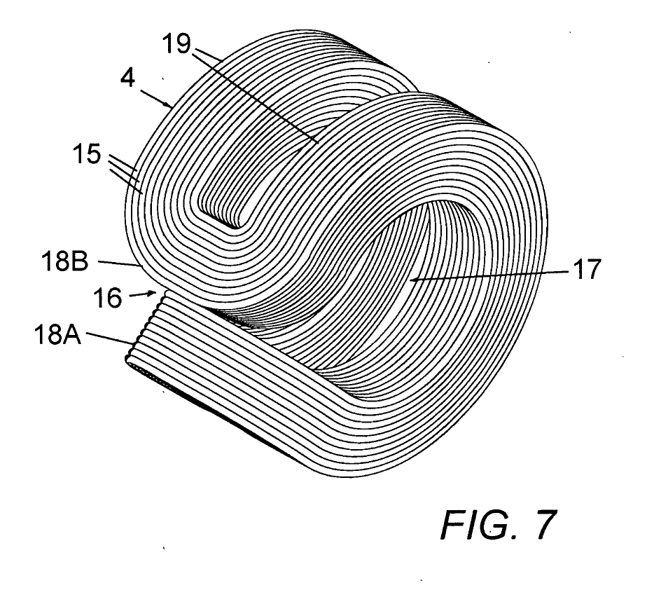

In FIGS. 1 and 6. the flywheel 1 for the flywheel electric generator system 20 comprises a flywheel 1 of substantial mass and thickness pivoting about a center axis 2. A thin annular disc 6 extends outwardly from an outer perimeter of the flywheel 1. The annular disc 6 has a thickness substantially less than the flywheel. A series of magnets 5 attached to an outer perimeter of the annular disc 6. The magnets 5 each having a mating identical peripheral shape. A source of rotational power causes the flywheel 1 to spin.

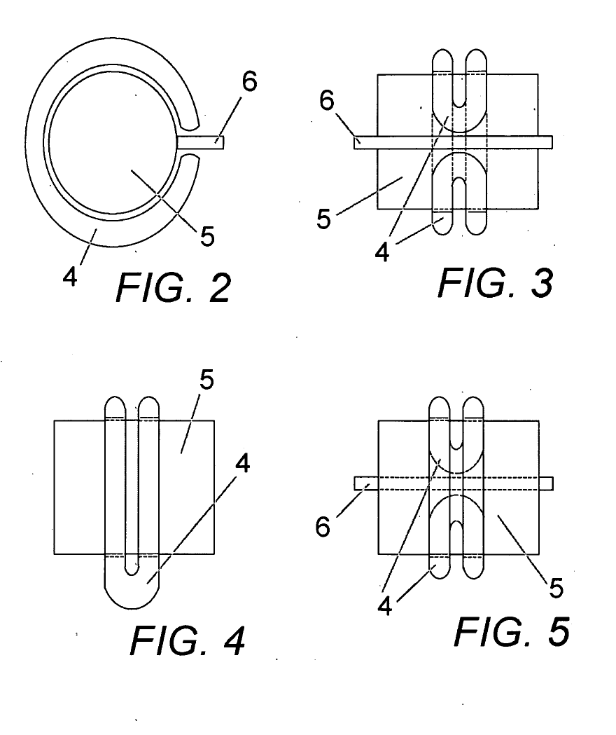

In FIGS. 2-5, 7 and 8, a series of coil loops 4 are attached to a structure separate from the flywheel 1, positioned in a circular array around the outside of the flywheel 1 out of contact with the flywheel. Each of the coil loops 4 comprises an elongated oval coil winding bent into an open loop configuration with the coil ends 18A and 18B of the elongated oval coil windings spaced apart in close proximity to form a coil end space 16 and 16A facing the flywheel 1 to receive the annular disc 6 spinning within the coil end space 16 and 16A without contacting the coil ends. The open loop configuration of the coil loop 4 forms an interior loop opening 17 and 17A mating the outer peripheral shape of each of the magnets 5, the interior loop opening 17 and 17A being slightly larger than the peripheral shape of each of the magnets 5 so that the magnets spin around as the attached flywheel 1 spins, with the magnets 5 each passing through all of the coil loops 4 with each rotation of the flywheel without contacting the coil loops. Each of the moving magnets 5 generates a flow of electricity is each of the coil loops 4. The flow of electricity generated in the coils 4 is transmitted from the coil loops 4 to devices for using and storing the flow of electricity.

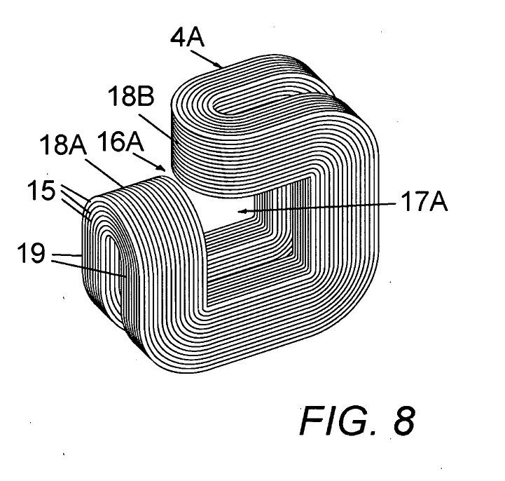

In FIGS. 7 and 8, each of the coil loops 4 and 4A comprises an electrically conductive wire 15 wound around two spaced posts in a multiplicity of windings to form a built up cable in the shape of a closed elongated oval loop with two parallel spaced sides 19 and two semicircular ends 18A and 18B which is bent into an open loop coil configuration having the two semicircular ends 18A and 18B positioned in close proximity to leave the coil end space 16 and 16A between the two semicircular ends 18A and 18B with the two parallel sides 19 forming two parallel loops around the interior opening 17 and 17A.

In FIGS. 1-7, each of the coil loops 4 has a circular (or oval) interior opening 17 to form a C-shaped coil loop used with magnets 5 each having a circular (or oval) peripheral shape.

In FIG. 8, each of the coil loops 4 has a rectangular interior opening 17A for a square shaped coil loop used with magnets 5 each having a rectangular peripheral shape.

The coil loops 4 may have any of a variety of shapes of interior opening 17 and 17A for any of a variety of shaped coil loops 4 used with magnets 5 each having any of a variety of mating peripheral shapes.

In FIGS. 1 and 6, the system 20 preferably comprises an electric motor 7 as a rotational force supply communicating with the flywheel 1 for maintaining the rotation of the flywheel 1 at a desired optimum level for efficiency. A means for detecting the flywheel speed of revolution 12, such as an RPM counter, controls a means for activating the electric motor 7, such as a time controller 8, to speed up the flywheel 1 to a desired rotational speed and deactivating the electric motor 7 upon detecting the desired rotational speed so that the flywheel 1 continues to spin by inertia for maximum output of electricity. The combination of speed of revolution of the flywheel 1, mass of the flywheel, and diameter of flywheel determine the desired rotational speed of the flywheel.

The flywheel 1 may be connected to a rotor of the electric motor 7 for turning the flywheel. Alternately, the flywheel 1 may be connected to the electric motor 7 through a transmission interface system 13 for spinning the flywheel.

To generate electric power in the coils by spinning the flywheel, the flywheel 1 may be connected to at least one of the following rotational power sources 9 taken from the list of rotational power sources comprising an electric motor, an electric motor powered from rechargeable batteries 9 preferably with a charge control 10 and wiring 11 connected to a time controller 8 to the electric motor 7 (shown in FIG. 1), an electric motor powered from rechargeable batteries powered by at least one solar panel, an electric motor powered from rechargeable batteries powered by at least one wind generator, an air motor, an air turbine, a wind turbine, an engine, a rotational force source from pressurized air, a rotational force source from pressurized vapor, a rotational force source from pressurized vapor of a liquid gas or other sources of rotational power.

A vacuum chamber 14, as shown in FIG. 6, may be used for containing the flywheel 1 and the series of coil loops 4 inside of the vacuum chamber to lower air resistance for greater efficiency in generating electricity.

The center axis 2 of the flywheel may comprise or connect with at least one of the following rotation devices taken from the list of rotation devices comprising bearings 3, low friction bearings, magnetic bearings, and electromagnetic bearings for minimizing rotational friction for optimum performance of the flywheel.

A great advantage of using a shaped loop wire coil is that it doesn't have any magnetic material inside and has a special type of coil winding with the elongated wire winding loop bent into a shaped loop which allows magnets to go through the winding of shaped loop coil itself. Because there is no magnetic material at all in the shaped loop coil, therefore there is no magnetic resistance at all, which allows the magnets to go through shaped loop coil freely, while at the same time electro magnetic induction from the magnets makes the winding of the shaped loop coil produce electric current. The shaped loop coil can have any type of shape of winding. What is most important is that it has a narrow opening in the windings facing the flywheel 1 to allow the disc 6 or other element holding the magnets 5 to fit through the narrow opening and maintain the magnets within the loop opening without touching the loop itself while the magnets 5 spin through all of the loops 4 with the spin of the flywheel 1.

In use, the flywheel 1 and flywheel axis 2 can be connected to the rotor of the electric motor 7 directly or it can be connected through a transmission (Interface System) 13 or it can be connected to any other Rotational Force Supply 9 such as (air motor, air or wind turbine any type of engines and other). The electric motor 7 powered from rechargeable batteries 9 or powered from any other Rotational Force Source 9, such as pressurized air, vapor of liquid nitrogen or other liquid gases and other sources depending on the type of Rotational Force Supply. Rechargeable batteries 9 can be charged from solar panels, wind generators or any other source of energy. The flywheel 1 and loop shaped coils 4 can be located inside of a vacuum chamber 14, to lower air resistance.

The electric motor 7 speeds up the flywheel 1 to a desired speed measured by an RPM (Revolutions Per Minute) counter and a time controller 8 and then the flywheel 1 is disconnected from the power from electric motor 7, and the flywheel 1 continues to spin by inertia force. When the flywheel 1 goes down below a set RPM, the time controller 8 which is connected with the RPM counter 12 turns on the electric motor 7 for several seconds to speed up the flywheel 1 for optimum set RPM. This cycle is constantly repeated to keep the flywheel spinning in diapason of maximum and minimum RPM. The duration of spinning of flywheel 1 is dependant on the speed, mass and diameter of the flywheel. When the flywheel 1 is spinning, the magnets 5 attached to the flywheel 1 or to a separated mounting located on the same axis 2, going through coils 4 to produce electric current.

The electric energy from the shaped loop coil flywheel electric generator system of the present invention can be used for different types of applications. It can be used as source of energy for houses, buildings, commercial buildings, factory and other production facilities. It can be used in power plants for towns and cities. It can also be used as a source of energy for land vehicles, marine vehicles, marine platforms and other types of vehicles.

Also the shaped loop coil flywheel generator of the present invention can be used as a source of energy in space for space stations or space vehicles. Because there is vacuum and no air resistance in space, the present invention can produce energy with high efficiency. And it can be used in many other applications by scaling up or scaling down the size of the device.

It is understood that the preceding description is given merely by way of illustration and not in limitation of the invention and that various modifications may be made thereto without departing from the spirit of the invention as claimed.

What is claimed is:

1. A flywheel electric generator system using loop shaped coils, the system comprising:
a flywheel for a flywheel electric generator comprising a flywheel of substantial mass pivoting about a center axis, an annular disc extending outwardly from an outer perimeter of the flywheel, the annular disc having a thickness substantially less than the flywheel, a series of magnets attached to an outer perimeter of the annular disc, the magnets each having a mating peripheral shape;
means for rotating the flywheel from a source of power;
a series of coil loops positioned in a circular array around the outside of the flywheel out of contact with the flywheel, each of the coil loops comprising an elongated oval coil winding bent into an open loop configuration with the coil ends of the elongated oval coil windings spaced apart in close proximity to form a coil end space facing the flywheel to receive the annular disc spinning within the coil end space without contacting the coil ends, the open loop configuration of the coil loop forming an interior loop opening mating the outer peripheral shape of each of the magnets, the interior loop opening slightly larger than the peripheral shape of each of the magnets so that the magnets spin around as the attached flywheel spins, with the magnets each passing through all of the coil loops with each rotation of the flywheel without contacting the coil loops, each of the magnets generating a flow of electricity is each of the coil loops;
means for transmitting the flow of electricity from the coil loops to devices for using and storing the flow of electricity.

2. The system of claim 1 wherein each of the coil loops comprises an electrically conductive wire wound around two spaced posts in a multiplicity of windings to form a built up cable in the shape of a closed elongated oval loop with two parallel spaced sides and two semicircular ends which is bent into an open loop coil configuration having the two semicircular ends positioned in close proximity with the two parallel sides forming two parallel loops around the interior opening.

3. The system of claim 2 wherein each of the coil loops has a circular interior opening for a C shaped coil loop used with magnets each having a circular peripheral shape.

4. The system of claim 2 wherein each of the coil loops has a rectangular interior opening for a square shaped coil loop used with magnets each having a rectangular peripheral shape.

5. The system of claim 2 wherein each of the coil loops has any of a variety of shapes of interior opening for any of a variety of shaped coil loops used with magnets each having any of a variety of mating peripheral shapes.

6. The system of claim 1 further comprising an electric motor communicating with the flywheel for maintaining the rotation of the flywheel at a desired optimum level for efficiency.

7. The system of claim 6 further comprising means for detecting speed of revolution of the flywheel and means for activating the electric motor to speed up the flywheel to a desired rotational speed and means for deactivating the electric motor upon detecting the desired rotational speed so that the flywheel continues to spin by inertia for maximum output of electricity.

8. The system of claim 7 wherein a combination of speed of revolution of the flywheel, mass of the flywheel, and diameter of flywheel determine the desired rotational speed of the flywheel.

9. The system of claim 6 wherein the flywheel is connected to a rotor of the electric motor for spinning the flywheel.

10. The system of claim 6 wherein the flywheel is connected to the electric motor through a transmission for spinning the flywheel.

11. The system of claim 1 wherein the flywheel is connected to at least one of the following rotational power sources taken from the list of rotational power sources comprising an electric motor, an electric motor powered from rechargeable batteries, an electric motor powered from rechargeable batteries powered by at least one solar panel, an electric motor powered from rechargeable batteries powered by at least one wind generator, an air motor, an air turbine, a wind turbine, an engine, a rotational force source from pressurized air, a rotational force source from pressurized vapor, and a rotational force source from pressurized vapor of a liquid gas for spinning the flywheel.

12. The system of claim 1 further comprising a vacuum chamber for containing the flywheel and the series of coil loops inside of the vacuum chamber to lower air resistance.

13. The system of claim 1 wherein the center axis of the flywheel comprises at least one of the following rotation devices taken from the list of rotation devices comprising bearings, low friction bearings, magnetic bearings, and electromagnetic bearings for minimizing rotational friction for optimum performance of the flywheel.
